(19) United States
(12) Patent Application Publication
(10) Pub. No.: US 2025/0061250 A1
(43) Pub. Date: Feb. 20, 2025

(54) MACHINE LEARNING AND AUGMENTED-REALITY FOR PROACTIVE THERMAL AMELIORATION

(71) Applicant: International Business Machines Corporation, Armonk, NY (US)

(72) Inventors: Jeremy R. FOX, Georgetown, TX (US); Carolina GARCIA DELGADO, Zapopan (MX); Mauro MARZORATI, Lutz, FL (US); Sarbajit K. RAKSHIT, Kolkata (IN)

(21) Appl. No.: 18/449,786

(22) Filed: Aug. 15, 2023

(51) Int. Cl. G06F 30/27

(52) U.S. Cl. CPC G06F 30/27; G06F 2111/18

(57) ABSTRACT

Method and apparatus for utilizing machine learning models to simulate and predict proactive actions in digital modeling. Data is collected from one or more sensors in a physical environment. A digital model depicting physical machinery in the physical environment is generated based on the sensor data. One or more operations of the physical machinery is simulated based on the digital model and the sensor data. Thermal conditions of the physical environment is predicted, using a machine learning (ML) model, based on the simulating of the operations and the sensor data. A recommendation comprising one or more proactive actions to mitigate potential thermal issues is generated, based on the predicted thermal conditions. The predicted thermal conditions, the identified potential thermal issues, and the one or more proactive actions are projected into the digital model via an augmented-reality (AR) display.

### BACKGROUND

The present disclosure relates to digital modeling, and more specifically, to utilizing machine learning models to generate and simulate proactive actions using digital modeling.

A digital twin is a virtual representation of a physical machine, product, system, process, or service. This representation provides a comprehensive model of the physical machine or system in a virtual environment, including its thermal conditions. The virtual representations are often generated by mapping real-time data collected from a variety of sources (e.g., sensors, cameras, internet-of-thing (IoT) devices, machinery control systems, and recording systems) into the virtual environment. By accessing the digital twin, users can evaluate real-time information about the physical machine or system without being physically present, which substantially increases accessibility and enables comprehensive remote monitoring and management.

### SUMMARY

One embodiment presented in this disclosure provides a method, including collecting data from one or more sensors in a physical environment, generating a digital model depicting physical machinery in the physical environment, based on the data collected from the one or more sensors, simulating one or more operations of the physical machinery, based on the digital model and the data collected from the one or more sensors, predicting thermal conditions of the physical environment, using a machine learning (ML) model, based on the simulating of the operations and the data collected from the one or more sensors, generating a recommendation comprising one or more proactive actions to mitigate potential thermal issues, based on the predicted thermal conditions, and projecting the predicted thermal conditions, the identified potential thermal issues, and the one or more proactive actions into the digital model via an augmented-reality (AR) display.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example computing environment for the execution of at least some of the computer code involved in performing the inventive methods.

FIG. 2 depicts an example environment in which embodiments of the present disclosure may be implemented.

FIG. 3 depicts an example of workflow for digital model creation, operation simulation, thermal signature prediction, and/or proactive action recommendation, according to some embodiments of the present disclosure.

FIG. 4 depicts an example method for creating digital models, simulating operations, predicting thermal signatures, and/or projecting proactive actions, according to some embodiments of the present disclosure.

FIG. 5 depicts a flow diagram depicting an example method for predicting thermal signatures and projecting proactive actions into digital models, according to some embodiments of the present disclosure.

FIG. 6 depicts an example computing system for proactive augmented-reality (AR) action projection, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments herein describe a method or system for utilizing machine learning models to predict thermal signatures, recommending proactive actions based on the predictions, and simulating/visualizing these proactive actions within digital modeling to access their mitigating effects on the predicted thermal signatures. As used herein, “proactive” actions may refer to the operations that are recommended and/or implemented based on a digital twin model, operational data, and/or thermal environmental data, with the intent to mitigate potential heat generation and propagation.

In one embodiment, the system may create a digital twin model for machines at an industrial location (e.g., warehouse, manufacturing plant floor, data center, construction site, etc.) based on real-time data associated with the machines (e.g., operations currently being performed or planned to be performed, machine loads or demands, maintenance information, health status, energy consumption, vibration, materials used for production, lubricant used coolant used, etc.) and/or surroundings (e.g., temperature, humidity, radiation, air flow, ventilation, etc.). In some embodiments, the real-time data may be collected from a variety of sources, such as sensors, IoT devices, thermal cameras, and the like. Using the created digital twin model and relevant operational data, the system may identify the existing thermal signatures of the industrial location where the machines are located, and simulate future operations. Based on these simulations, the system may use one or more trained machine learning (ML) models to predict potential future heat generation and propagation. In some embodiments, one or more trained ML models may also be used to determine and/or recommend which proactive actions should be taken to mitigate the predicted heat generation and propagation. In some embodiments, the system may also project the recommended proactive actions into the digital model, enabling users to visualize the potential mitigating effects, and, therefore, make decisions more effectively and efficiently.

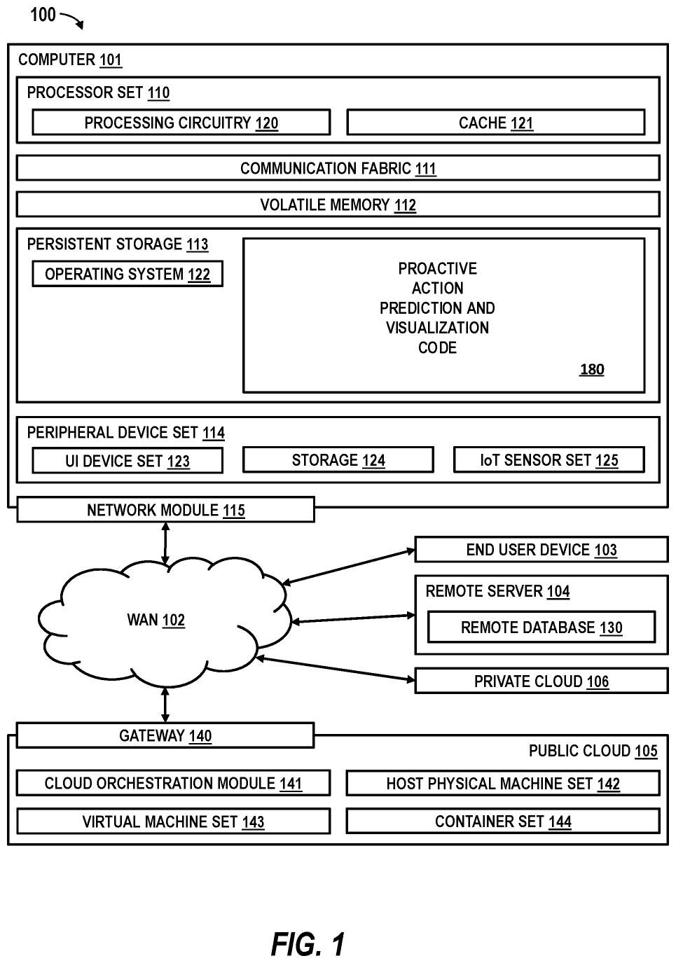

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Proactive Action Prediction and Visualization Code 180. In addition to Proactive Action Prediction and Visualization Code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Proactive Action Prediction and Visualization Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Proactive Action Prediction and Visualization Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Proactive Action Prediction and Visualization Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

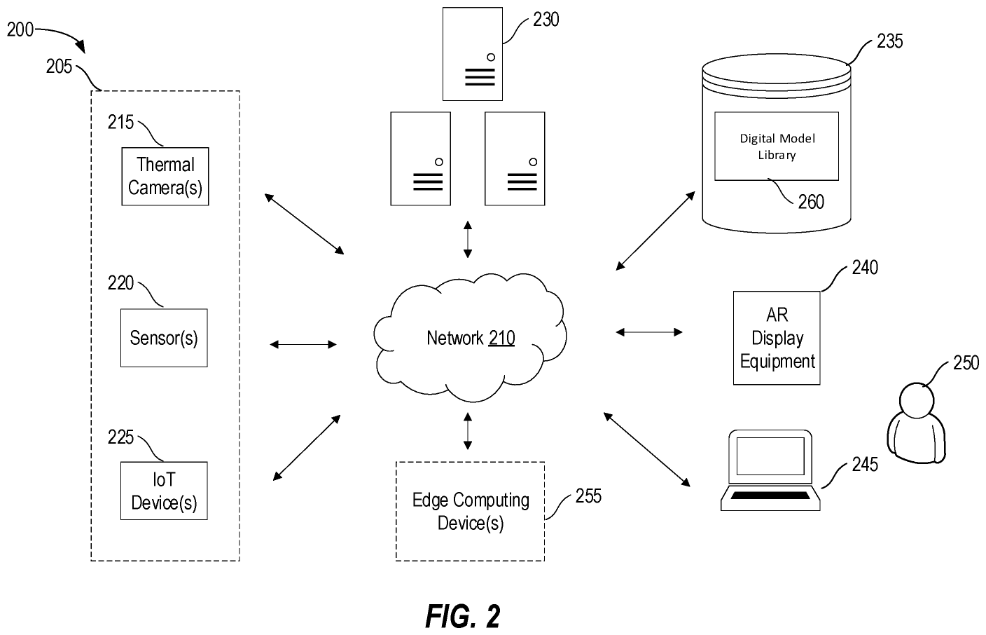

FIG. 2 depicts an example environment 200 in which embodiments of the present disclosure may be implemented. In the illustrated example, the environment 200 includes one or more thermal cameras 215, one or more sensors 220, one or more internet-of-thing (IoT) devices 225, one or more servers 230, a database 235, one or more client devices 245, and one or more augmented-reality (AR) display equipment accessed by a client 250. In some embodiments, one or more of the illustrated devices may be a physical device or system. In other embodiments, one or more of the illustrated devices may be implemented using virtual devices, and/or across a number of devices.

In the illustrated example, the thermal cameras 215, the sensors 220, the IoT devices 225, the servers 230, the database 235, the client devices 245, and the AR display equipment 240 are remote from each other and communicate with each other via a network 210. Each of the devices may each be implemented using discrete hardware systems. The network 210 may include or correspond to a wide area network (WAN), a local area network (LAN), the Internet, an intranet, or any combination of suitable communication mediums that may be available, and may include wired, wireless, or a combination of wired and wireless links. In some embodiments, each of the devices may be local to each other (e.g., within the same local network and/or the same hardware system), and communicate with one another using any appropriate local communication medium, such as a local area network (LAN) (including a wireless local area network (WLAN)), hardwire, wireless link, or intranet, etc.

In one embodiment, the thermal camera(s) 215 may be installed (e.g., in the ceiling) in an industrial location 205 (e.g., warehouse, manufacturing plant floor, data center, construction site, etc.) that includes one or more pieces of machinery or systems. The thermal camera(s) 215 may be used to continuously scan, monitor, and/or record the thermal patterns across the industrial location 205. In some embodiments, the thermal camera(s) 215 may be configured to generate one or more thermal images of the industrial location based on the scanned thermal patterns presented in the environment. In some embodiments, the thermal images provide a virtual representation of the thermal distribution in the industrial location 205. The images may use different colors to highlight areas with varying temperatures, and may identify spots with excessive heat generation and/or propagation. In some embodiments, the generated thermal images may be transmitted directly to the server 230 for processing. This processing may involve detailed and advanced analysis and prediction, for example, in some embodiments, using ML models or algorithms to predict future heat generation and/or propagation based on current conditions, and, based on the predictions, determining one or more proactive actions that may be taken to prevent and/or mitigate the potential thermal-related hazards. In some embodiments, the thermal images may be stored in the database 235 for future analysis. In some embodiments, the thermal camera(s) 215 may be configured to generate thermal images at specific intervals or in response to certain triggers, such as a sudden increase in temperature.

In some embodiments, the sensor(s) 220 and IoT device(s) 225 may be installed either in proximity to or remotely from the machines, systems, or raw materials within the industrial location 205. The sensor(s) 220 and IoT device(s) 225 may be used to gather data associated with both the operations of the machines or systems and the environmental conditions surrounding them. The operational data associated with the machines or systems may include statistics related to operations (or activities) currently being performed or scheduled to be performed by the machines, such as maintenance information, energy consumption, health status, vibration, friction, lubricant degradation and/or amounts of lubricant used, coolant degradation and/or amounts of coolant used, coolant flow rate, and/or other operational data/parameters. The environmental data may include information such as temperature, humidity, radiation, air flow, ventilation, and/or other environmental data/parameter. In some embodiments, the data collected from various sources (e.g., sensors 220, and IoT devices 225) may be transmitted directly to the server 230 for processing. In some embodiments, the data may be stored in the database 235 for future analysis. In some embodiments, the sensors 220 and/or the IoT device 225 may be configured to transmit data at specific intervals or in response to certain triggers, such as a sudden temperature increase or a surge in machine load or demand.

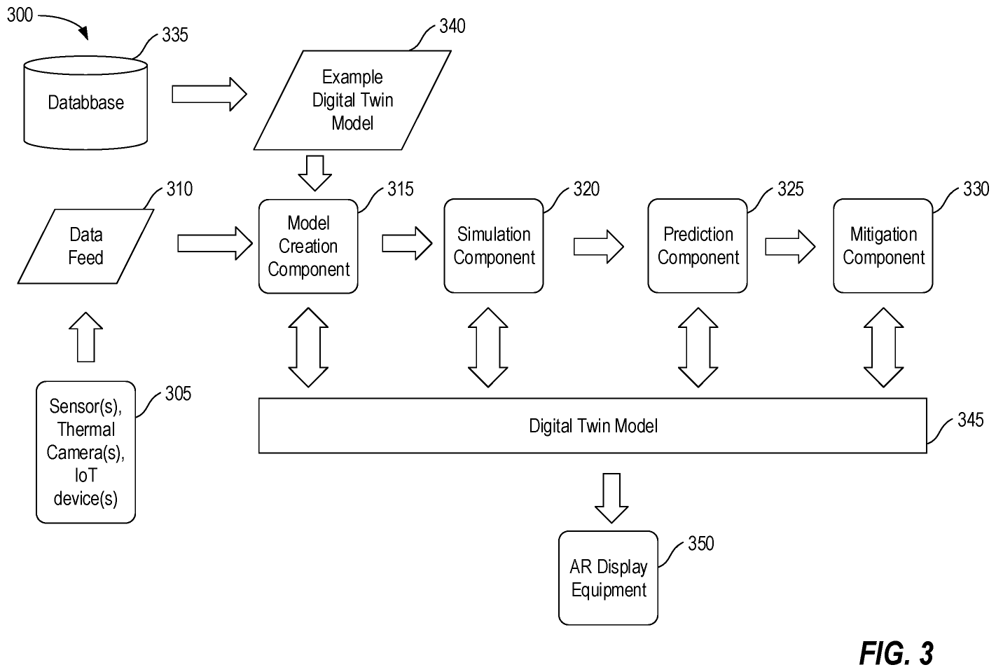

In the illustrated example, the database 235 comprises a digital model library 260. The digital model library 260 may comprise a set of example digital twin models associated with different machines, systems, structures, or industrial locations. These example digital models may be generated based on historical data associated with data feeds (e.g., 310 of FIG. 3) collected from various sources (e.g., thermal cameras 215, the sensors 220, and the IoT device 225). The database may be accessed by the server(s) 230 in creating digital twin models, simulating operations, predicting heat generation and propagation, recommending proactive or remedial actions, projecting the recommended actions into digital twin models, and/or the like, as discussed in more detail below.

In the illustrated example, the server 230 is capable of accessing, retrieving, and processing the example digital twin models and their substantive data stored in the database 235. Based on the type of each machine at the current industrial location, in some embodiments, the server 230 may identify one or more relevant example digital twin models from the set of example digital twin models. In some embodiments, relying on the chosen example digital twin models and their substantive data, along with the data feeds received from the various sensors (e.g., thermal cameras 215, the sensors 220, and the IoT device 225) at the industrial location, the server 230 may create a virtual representation (also referred to in some aspects as a digital twin model) (e.g., a 3D model) of the industrial location. The virtual representation may include or reflect both physical and environmental factors that can impact the thermal conditions of the industrial location. For example, if the industrial location is a manufacturing plant floor, the virtual representation may include details of the machines located on the floor, such as the geometry, size, and location of these machines, as well as the materials used in their construction and production. Additionally, in some embodiments, the server may also incorporate environmental factors, such as humidity, air flow, and ventilation, into the virtual representation of the industrial location. In some embodiments, the server 230 may perform simulations of operations being executed or planned for near future by the machines or systems. Using the data feeds and the digital twin model, the server 230 may simulate various operational conditions of the machines or systems based on current conditions and operational trends. In some embodiments, the server 230 may interpret the simulation results, and/or generate visualizations of the simulation results, such as heat maps, graphs, and charts for further processing. In some embodiments, the virtual representation (e.g., a 3D model) of the industrial location, along with the visualizations of the simulation results (e.g., heat maps, graphs, and charts), may be transmitted to the client device(s) 245 and/or AR display equipment 240 for display and/or review.

In some embodiments, based on these simulation results, the server(s) 230 may predict potential heat generation and propagation using a trained ML model. The predictions may provide valuable insights into how the thermal conditions of the industrial location may be affected by changes in the environment and operations, and reveal potential issues related to the thermal conditions. Based on the predictions, in some embodiments, the server(s) 230 may determine and/recommend certain proactive actions that should be taken to prevent or mitigate the potential thermal-related issues. The proactive actions may include a variety of operations, such as adjusting the operation of the machines (e.g., replacing machine parts, changing lubricant, or decreasing machine load), altering the environmental conditions (e.g., increasing air flow), or implementing specific cooling measures (e.g., increasing coolant flow, changing coolant used in the industrial location, or activing heat recovery systems).

In some embodiments, the server(s) 230 may integrate these proactive actions and their mitigating effects into the digital twin model, through which, the client 250 may view the potential impact of these actions on the overall thermal conditions of the industrial location in the via the device(s) 245 and/or AR display equipment 240. The process of visualizing these proactive actions enables the client 250 to make more informed decisions to manage heat within the industrial location.

In the illustrated example, the client device(s) 245 and the AR display equipment 240 may be used to display the digital twin model of the industrial location, the related simulation results (e.g., heat maps, graphs, and charts), and predictive analysis (e.g., predicted heat generation and propagation, recommended proactive actions and their mitigating impacts) to the client 250. In one embodiment, the client device(s) 245 and the AR display equipment 240 may also serve as an interface between the server 230 and the client 250, allowing the client 250 to provide feedback on the received results. Using the client device(s) 245 and the AR display equipment 240, the client 250 may adjust parameters, run simulations on different scenarios, and provide inputs on the predicted outcomes. The client's feedback may then be incorporated into further simulations and predictions, further improving the system's efficiency and accuracy.

In some embodiments, the environment 200 may further comprise one or more edge computing devices 255, which serve to collect and/or process the data near the source (e.g., the industrial location 205), instead of sending all the data to the central server 230 for processing. The edge computing device(s) 255 may perform edge computations locally, which can effectively reduce latency and increase response speed. The edge computations may include performing thermal simulations using the data collected from different sources (e.g., thermal cameras 215, sensors 220, and IoT device 225), and/or making predictions and recommendations based on the simulation results. When such edge computations are complete, the edge computing device(s) 255 may transmit these results to the server(s) 230 for further processing and visualization. In some embodiments, the transmission may be performed over secure network connections using standard communication protocols, such as MQTT or HTTP. The server(s) 230, upon receiving these results, may map the thermal simulations and predictions into a detailed digital twin (e.g., 3D model) of the industrial location. The resulting visualization provides an immersive and comprehensive view of the industrial location, highlighting potential heat generation and propagation, and illustrating the effects of potential proactive actions recommended by the system.

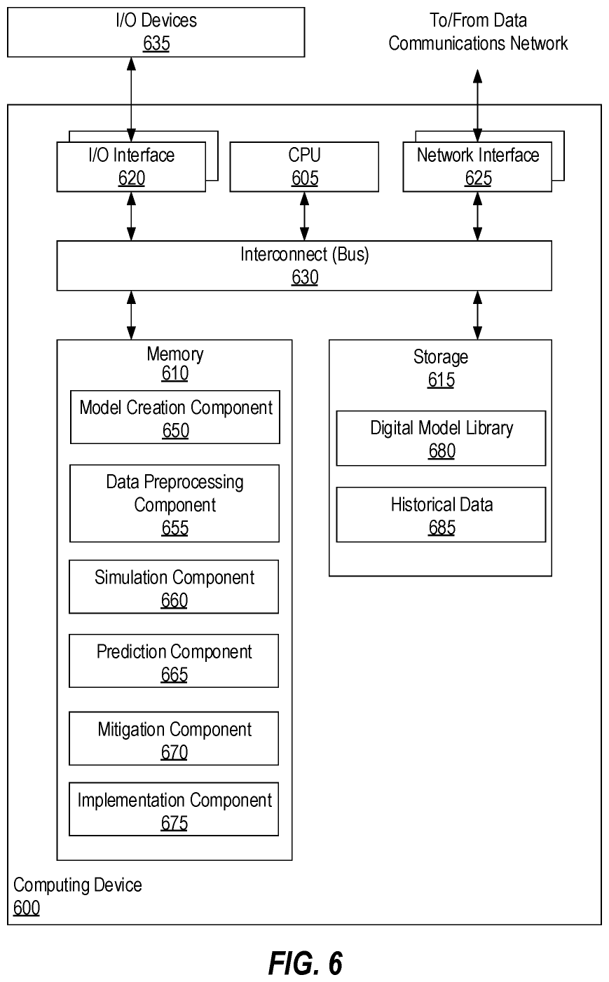

FIG. 3 depicts an example of workflow 300 for digital model creation, operation simulation, thermal signature prediction, and/or proactive action recommendation, according to some embodiments of the present disclosure. In some embodiments, the workflow 300 of FIG. 3 may be performed by one or more computing devices, such as the computer 101 as illustrated in FIG. 1, the server(s) 230 and/or the edge computing device(s) 255 as illustrated in FIG. 2, and/or the computing device 600 as illustrated in FIG. 6. Though depicted as discrete components for conceptual clarity, in some embodiments, the operations of the depicted components (and others not depicted) may be combined or distributed across any number and variety of components, and may be implemented using hardware, software, or a combination of hardware and software.

In the illustrated example, one or more sensors, thermal cameras, and/or IoT devices (e.g., 305 of FIG. 3) are installed in an industrial location, and are used to generate the data feeds 310 and transmit them to the model creation component 315. The data feeds 310 may include data associated with the operations of the machines or systems at the industrial location (also referred to in some embodiments as operational data), as well as data associated with the machinery's surroundings (also referred to in some embodiments as environmental data or thermal environmental data). In some embodiments, the operational data may include statistics related to activities being performed or to be performed by the machinery or systems, such as maintenance information, energy consumption, health status, vibration, friction, lubricant used, coolant used, coolant flow rate, and/or other operational data/parameters. In some embodiments, the environmental data may include data such as temperature, thermal imaging, humidity, radiation, air flow, ventilation, and/or other environmental data/parameters that may impact the thermal conditions of the industrial location. As stated above, in some embodiments, the thermal cameras may continuously scan and monitor the thermal patterns across the industrial location, and generate a thermal image at specific intervals to illustrate the heat generation and distribution across the location.

In the illustrated example, the model creation component 315 receives the data feeds 310 associated with the machines and/or surroundings. In some embodiments, the model creation component 315 may preprocess the data feeds 310 to make them ready for generating a digital twin model. In some embodiments, the preprocessing process may begin with data cleaning, which involves eliminating any errors, incomplete data, or irrelevant entries (e.g., outliers) from the collected data. For example, any errors or outlier data points may be identified and removed based on other available data points. In some embodiments, the preprocessing process may further include data integration, which involves resolving inconsistencies, such as unifying units of measurement or data formats, to ensure that all data are aligned correctly. Once the data is clean and integrated, in some embodiments, the preprocessing process may then proceed to data transformation, which involves transforming the data into a suitable format for digital twin modeling and simulating. In some embodiments, the data collected by the thermal cameras may be in the form of images, which should be converted to numerical data by the model creation component 315 before feeding into the simulation component 320.

As illustrated, the model creation component 315 accesses the database 335 to retrieve one or more example digital twin models 340 associated with the machines at the industrial location. The database 335 (e.g., 235 of FIG. 2) may comprise a digital model library (e.g., 260 of FIG. 2). The digital model library may include numerous example digital twin models related to different machines, systems, structures, or industrial locations. These example digital models may be generated based on historical data associated with data feeds (e.g., 310 of FIG. 3) collected from various sources (e.g., thermal cameras 215, the sensors 220, and the IoT device 225). Based on the type or specification of the machines at the current industrial location, the model creation component 315 may identify one or more relevant example digital twin models, and create a digital twin model of the current industrial location more efficiently.

As illustrated, the model creation component 315 may use the selected example digital twin models 340 and the data feeds 310 received from the various sensors 305 at the industrial location to create a virtual representation (also referred to in some aspects as a digital twin model) (e.g., a 3D model) of the industrial location. The digital twin model 345 of the industrial location may include details of the machines located in the industrial location, such as the geometry, size, and location of these machines, as well as the materials used in their construction. In some embodiments, the digital twin model 345 may also include environmental factors that may impact the thermal conditions (also referred to in some embodiments as thermal signatures) of the industrial location. The environmental factors may include temperature, thermal imaging, humidity, infrared radiation, air flow, ventilation, and the like. In some embodiments, the model creation component 315 may create the digital twin model 345 using specialized software, such as a 3D modeling tool.

In the illustrated example, after the digital twin model 345 of the industrial location is created, the simulation component 320 begins to simulate the operations of the machines, and/or the thermal conditions of the machinery based, at least in part, on the digital twin model (e.g., 3D model) 345 and the data feeds 310. For example, the simulation component 320 may simulate operations (or activities) being performed or to be performed based on the digital twin model 345 and the data feed 310. The simulation may include different scenarios, such as varying operation loads or speeds, different environmental conditions, or hypothetical equipment malfunctions, in order to predict the machinery's behavior under varying conditions. In some embodiments, the simulation component 320 may simulate the thermal conditions of the industrial location where the machines are located. For example, the simulation component 320 may simulate the heat generation and propagation on an industrial floor with different sets of parameters, such as the health of the machine, operations (or activities) being performed or to be performed, operational loads or demands, human-machine interactions, materials used for production, lubricants used, and/or coolants used, in order to understand the impact of different parameters on thermal conditions. In some embodiments, the simulation may be performed to identify potential issues related to thermal conditions, and make predictions about future thermal conditions. In some embodiments, the simulation of the thermal conditions may be performed based, at least in part, on the digital twin model 345, the data feed 310, and/or the simulation results of the operations of the machinery. In some embodiments, the computing system may use parameters (e.g., from data feeds 310) such as amount of friction, vibration, lubricant type, coolant type, coolant flow rate, environmental conditions (e.g., humidity, temperature, thermal imaging, air flow, ventilation, infrared radiation, etc.), operational parameters (e.g., payload, power consumption, grounding, part damage, etc.), current conditions, and/or the like in simulating operations and thermal environment/surroundings based on the digital twin model 345. In some embodiments, the computing system may also use a historical knowledge corpus (e.g., historical simulation data and corresponding operational and environmental data) in simulating the operations with regard to the occurrence of potential thermal issues to be predicted.

In some embodiments, the simulation component 320 may interpret the simulation results, and/or generate visualizations of the simulation results, such as heat maps, graphs, and charts, for further processing. The interpretation process may focus on identifying patterns, trends, and correlations in the data, and may highlight any areas of concern or potential issues related to thermal conditions. For example, in some embodiments, the heat map may use various colors to highlight areas with different temperatures, and may identify existing or potential spots with excessive heat generation and/or propagation. The heat map may also use one or more arrows or other indicators to show air or coolant flow direction and/or flow rate. In some embodiments, graphs and charts may be created to show the correlation between heat generation and/or propagation and different parameters, such as machine load, lubricant type, coolant type, coolant flow rate, ventilation rate, air flow, and the like.

In the illustrated example, the prediction component 325 receives the simulation results, and integrates them with trained machine learning models to make predictions and recommendations. The simulation results (e.g., including operational data, environmental data, machine health and load, and/or material used) may be used as inputs to ML models to make predictions about future thermal conditions (e.g., heat generation and/or propagation), identify potential thermal issues, and recommend effective measures for eliminating or mitigating these potential concerns. For example, by incorporating variables such as the type of activities currently being performed or scheduled to be performed by the machine, the type of lubricants used, and the current machine load, the ML model may predict the heat generation in different parts of the machines under different scenarios, and identify potential thermal-related issues that necessitate proactive measures to prevent their occurrence and/or reduce their level/severity before they occur. The ML models may also predict the overall thermal conditions of the industrial location under different environmental conditions, such as humidity and air flow, to identify how the thermal conditions will be affected by changes in the environment.

In some embodiments, the identification of potential thermal-related issues to be mitigated and/or prevented (e.g., based on the predicted thermal conditions) may include determining that a parameter (e.g., temperature, radiation level) associated with the machines and/or the industrial location will exceed a defined threshold. For example, if the ML models predict that the temperature of a particular area in the industrial location will exceed the safe operating limit, the prediction component 325 may indicate a potential overheating issue. In some embodiments, the threshold may be set based on operating limits, safety guidelines, or historical performance data.

In some embodiments, the ML models may be trained using historical data (e.g., historical simulation data and corresponding operational and environmental data) as inputs, and historical thermal conditions (also referred to in some embodiments as thermal signatures) as target outputs. Through the training process, the models may learn the underlying patterns and relationships in the data, and use these to make accurate predictions about the future thermal conditions of an industrial location. In some embodiments, the ML models may be trained using a variety of algorithms, including but not limited to support vector regression (SVR), random forest regression, and potential deep learning techniques such as neural networks (e.g., convolutional neural networks (CNNs) or recurrent neural networks (RNNs)). In some embodiments, the developed models may be evaluated and tested for their accuracy, reliability, and robustness. In some embodiments, a portion of the available historical data may be set aside for validation and testing. When the training process is complete, the model may be evaluated on the validation dataset (e.g., different dataset from the training dataset). For example, the models may be fine-tuned by adjusting the hyperparameters of these models, to prevent overfitting to the training dataset and improve their performance. Additionally, in some embodiments, the fine-tuned models may then be tested on the testing dataset (e.g., different dataset from the training and validation datasets). The performance of the fine-tuned models may be evaluated by comparing the predicted results (e.g., predicted thermal conditions of the industrial location) with the actual results (e.g., historical thermal conditions of the industrial location).

In the illustrated example, the mitigation component 330 determines one or more mitigation or preventive procedures based on the one or more predicted results (e.g., the thermal conditions of the industrial location, and the potential thermal-related issues). For example, the mitigation component 330 may recommend one or more mitigation and/or preventive procedures to avoid the potential thermal issues and/or reduce the severity/level of the potential thermal issues identified by the prediction component 325. In some embodiments, the mitigation component 330 may recommend mitigation and/or preventive procedures such as adjusting the cooling system, replacing some machine parts, stopping certain operations, changing the lubricants and coolants used in the industrial location, or implementing a heat recovery system. In some embodiments, the recommendations may be generated by one or more trained ML models that have learned to predict effective mitigation or preventative procedures based on historical data. The ML model may be trained by using historical data (e.g., historical simulation data and corresponding operational and environmental data) as inputs, and effectiveness of past mitigation procedures as target outputs. In some embodiments, the ML model trained to predict thermal conditions of the industrial location may also be trained to recommend proactive actions, which may provide consistency in the prediction and mitigation process and allow the model to understand the cause-and-effect relationship between the predicted thermal issues and the recommended proactive actions. In some embodiments, ML models trained to recommend proactive actions may be different from the ML models trained to predict thermal conditions. For example, the ML models trained to predict thermal conditions may use one type of algorithm, focusing on make accurate thermal predictions, while the ML models trained to recommend proactive actions may use a different type of algorithm, focusing on selecting the most effective mitigation strategies.

As illustrated, the prediction results (e.g., thermal conditions of the industrial location), the recommended proactive procedures and their corresponding mitigation and/or preventive effects may be projected and/or mapped into the digital twin model 345, allowing users to visually inspect how and where these issues may arise in the physical space of the industrial location, as well as the mitigation and/or preventive effects after implementing the recommended procedures. In some embodiments, heat maps, graphs, and/or other relevant visual indicators may be generated to show the predicted thermal conditions of the industrial location, and be overlaid into the digital twin model 345. Through the projection/mapping process, the digital twin servers not only as a virtual representation of the physical and thermal environment of the industrial location, but also as a predictive tool that offers valuable insights into potential thermal issues and the implication of different mitigation and/or preventive procedures. In some embodiments, the digital twin model 345 may be integrated into an augmented-reality (AR) system (e.g., displayed by an AR display equipment 350) to provide a more immersive view of the industrial location, allowing the user to more easily understand where thermal issues or hazards may arise, their potential impacts, and how they might be mitigated or prevented.

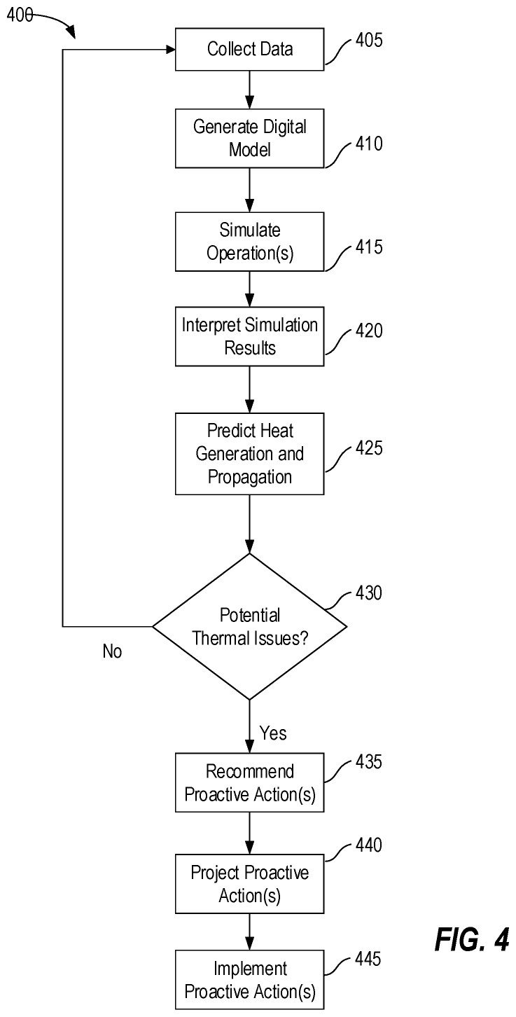

FIG. 4 depicts an example method 400 for creating digital models, simulating operations, predicting thermal signatures, and/or projecting proactive actions, according to some embodiments of the present disclosure. In some embodiments, the example method 400 may be performed by a computing device, such as the computer 101 of FIG. 1, the server(s) 230 or the edge computing device(s) 255 of FIG. 2, or the computing device 600 of FIG. 6.

The method 400 begins at block 405, where a computing system (e.g., server(s) 230 of FIG. 2) collects data from a variety of sensors (e.g., 220 of FIG. 2), thermal cameras (e.g., 215 of FIG. 2), or IoT devices (e.g., 225 of FIG. 2), which are installed either in proximity to or remotely from the machines, systems, or even raw materials within an industrial location 205. In some embodiments, the data collected may include data associated with the machinery or systems (also referred to in some embodiments as operational data), such as machinery load or demand, statistics related to activities being performed or scheduled to be performed, maintenance information, energy consumption, health status, vibration, friction, lubricant type, coolant type, coolant flow rate, and other operational data/parameters. In some embodiments, the data collected may further include environmental data associated with the machinery's surroundings (also referred to in some embodiments as environmental data or thermal environmental data), such as temperature, thermal imaging, humidity, infrared radiation, air flow, ventilation, and/or the other environmental data/parameters.

At block 410, the computing system generates a virtual representation (also referred to in some aspects as a digital twin model) (e.g., a 3D model) of the industrial location (e.g., including the machines, structures, or systems, as well as their surroundings). As stated above, the digital twin model refers to a detailed and comprehensive virtual representation of the physical setup of the industrial location. It may capture physical factors of the machines and their surroundings, such as the geometry, size, layout of the machines, and/or the materials used in their construction, offering a complete digital replica of the location. In some embodiments, the digital twin model may also include environmental factors that will impact the thermal conditions of the industrial location. In some embodiments, the digital twin model may be created using specialized software, such as a 3D modeling tool.

In some embodiments, the computing system may preprocess the data collected from various sensors before integrating them to create the digital twin model. In some embodiments, the preprocessing process may include data cleaning (e.g., deleting errors and outliers), data integration (e.g., resolving inconsistencies, unifying units of measurement or data format), and data transformation (e.g., transforming the data into suitable formats for digital twin modeling and simulating). In some embodiments, the computing system may access a digital twin library (e.g., 260 of FIG. 2) to retrieve one or more existing example digital twin models (e.g., 340 of FIG. 3) associated with the machines at the industrial location. In some embodiments, the example digital twin models may be identified based on the type, size, and/or model number of the machines at the industrial location. In some embodiments, the computing system may generate a virtual representation (e.g. the digital twin model 345 of FIG. 3) of the industrial location based on the data collected from various sensors (e.g., data feeds 310 of FIG. 3), and the selected example digital twin models (e.g., 340 of FIG. 3).

At block 415, the computing system uses the digital twin model (e.g., 345 of FIG. 3) created at block 410 to simulate the operations of the machines, and/or the thermal environment/surroundings of the industrial location where the machines are located. For example, in some embodiments, the computing system may simulate operations (or activities) currently being performed or scheduled to be performed based on the digital twin model and the data collected from various sensors (e.g., sensors 220, thermal cameras 215, or IoT devices 225 of FIG. 2). In some embodiments, the computing system may simulate the overall thermal conditions of the industrial location based at least in part on the simulated operations being performed or to be performed by the machines or systems, and the environmental parameters. In some embodiments, the simulation may be run with different sets of inputs with varying parameters to understand the impact of different parameters (e.g., machine load, coolant type, lubricant type) on thermal conditions. For example, in one embodiment, the simulation may be run with different machine loads to understand how the machine load may affect the thermal conditions. In another embodiment, the simulation may be run with different lubricant types to identify the best lubricant for a given situation.

At block 420, the computing system interprets the simulation results, which may include understanding the results, extracting meaningful insights from the simulation results, and transforming these results into suitable formats to be used by trained ML models to make predictions and recommendations. In some embodiments, the computing system may generate visualizations of the simulation results, such as heat maps, graphs, and charts, to make the ML models more easily understand the results.

At block 425, the computing system uses the simulation results (e.g., including operational data, environmental data, machine health and load, and/or material used) as inputs to ML models, and makes predictions about future thermal conditions (e.g., heat generation and/or propagation) of the industrial location. For example, the computing system may predict the heat generation in different parts of the machines based at least in part on the simulated operations being performed or to be performed, the machine health status, the machine loads, the lubricant used, the coolant used and the flow rate. The computing system may also predict the overall heat propagation in the industrial location, by considering environmental parameters, such as the current temperature, humidity, air flow, ventilation rate, etc.

At block 430, the computing system determines if any potential thermal issues may arise. The potential thermal issues may refer to conditions or situations (e.g., overheating in certain areas, unusual heat propagation, or unexpected heat spikes) that necessitate proactive actions to prevent their occurrence and/or to reduce their level/severity before they occur. In some embodiments, the computing system may identify a potential thermal issue upon determining that a parameter (e.g., temperature, radiation level) associated with the equipment and/or the industrial location exceeds a defined threshold. If the computing system predicts, using the ML model, that one or more potential thermal issues may arise in the future (e.g., a parameter exceeding a defined threshold), the method 400 moves to block 435, where the computing system recommends proactive actions to prevent or mitigate these issues. Otherwise, the method 400 returns to block 405, where the computing system continuously monitors the machine operations and the thermal conditions of the industrial location, and collects relevant data.

At block 440, the computing system projects the predicted thermal conditions of the industrial location (e.g., heat generation and propagation), the identified potential thermal issues and/or their impacts, as well as the recommended proactive measures and/or their corresponding mitigation and/or preventive effects onto the digital twin model (e.g., 345 of FIG. 3). The projection process allows the user to visually inspect where thermal issues might occur, what their potential impacts might be, and how they could be mitigated or prevented.

At block 445, the computing system implements the proactive actions based on the updated digital twin model. For example, in some embodiments, the computing system may optimize the cooling system settings, such as increasing the coolant flow rate, improving ventilation, or changing to a more efficient coolant type. In some embodiments, the computing system may mitigate or prevent the potential thermal issues by adjusting the operating conditions of the machines, such as reducing machine load, halting certain operations, or changing the type of lubricant used. In some embodiments, the computing system may mitigate or prevent the potential thermal issues by activating a heat recovery system. In some embodiments, the computing system may implement these recommended measures autonomously. In some embodiments, the computing system may implement these measures with some human supervision and/or intervention, depending on the level of automation and the complexity of the intervention required.

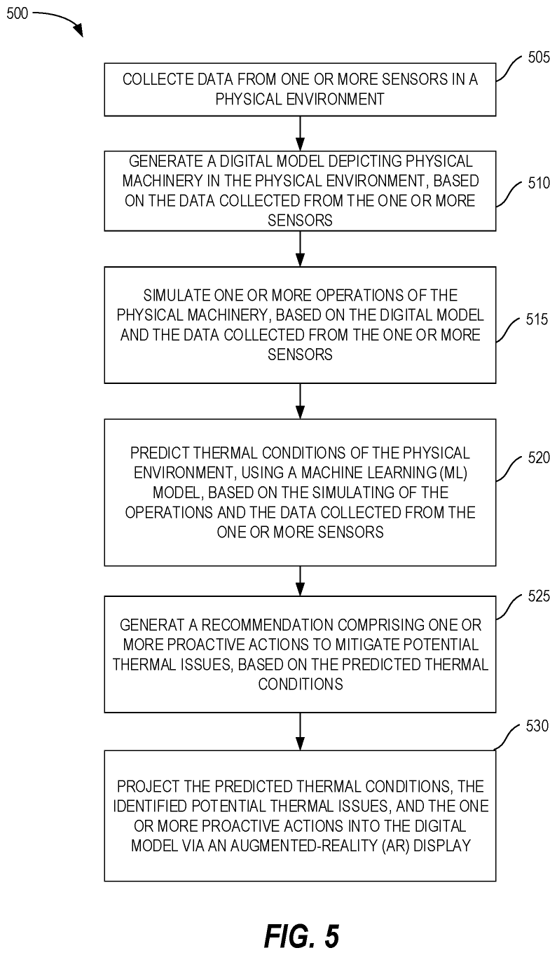

FIG. 5 is a flow diagram depicting an example method 500 for predicting thermal signatures and projecting proactive actions into digital models, according to some embodiments of the present disclosure. In some embodiments, the example method 400 may be performed by a computing device, such as the computer 101 of FIG. 1, the server(s) 230 or the edge computing device(s) 255 of FIG. 2, or the computing device 600 of FIG. 6.

The method 500 begins at block 505, where a computing system collects data from one or more sensors (e.g., sensors 220, IoT devices 225, or thermal cameras 215 of FIG. 2) in a physical environment/location. In some embodiments, the one or more sensors may comprise a temperature sensor, a thermal imaging camera, a humidity sensor, or an air flow sensor, an infrared radiometer, and/or a heat flux sensor. In some embodiments, the data collected from the one or more sensors may include the operational data associated with the physical machinery, and/or thermal environmental data of the industrial location where the machinery is based. In some embodiments, the thermal environmental data may comprises temperature, thermal imaging, humidity, air flow, coolant flow, heat influx, and/or infrared radiation.

At block 510, the computing system generates a digital model (e.g., 345 of FIG. 3) depicting the physical machinery in the physical environment based on the data (e.g., 310 of FIG. 3) collected from the one or more sensors (e.g., sensors 220, IoT devices 225, or thermal cameras 215 of FIG. 2).

At block 515, the computing system simulates one or more operations of the physical machinery based on the digital model (e.g., 345 of FIG. 3) and the data (e.g., 310 of FIG. 3) collected from the one or more sensors.

At block 520, the computing system predicts the thermal conditions of the physical environment, using a machine learning (ML) model, based on the simulating of the operations and the data collected from the one or more sensors. In some embodiments, the ML model comprises a neural network algorithm, and is trained to predict the thermal conditions of the industrial location. In some embodiments, the ML model is trained by using historical simulation data and historical data collected from the one or more sensors as input, using historical thermal conditions as target output, and where the ML model learns to correlate the historical simulation data and the historical data collected from the one or more sensors to the historical thermal conditions.

At block 525, the computing system generates a recommendation comprises one or more proactive actions to mitigate potential thermal issues, based on the predicted thermal conditions. In some embodiments, the one or more proactive actions may comprise at least one of dynamically controlling coolant flow, activating cooling procedures, or implementing heat recovery measures.

At block 530, the computing system projects the predicted thermal conditions, the identified potential thermal issues, and the one or more proactive actions into the digital model (e.g., 345 of FIG. 3) via an augmented-reality (AR) display. In some embodiments, the computing system may further predict the mitigating effects for each of the one or more proactive actions, and update the digital model to reflect the predicted mitigating effects for each of the one or more proactive actions. In some embodiments, the computing system may further implement the one or more proactive actions based on the updated digital model.

FIG. 6 depicts an example computing device 600 for proactive augmented-reality (AR) action projection, according to some embodiments of the present disclosure. Although depicted as a physical device, in embodiments, the computing device 600 may be implemented using virtual device(s), and/or across a number of devices (e.g., in a cloud environment). The computing device 600 may be any type of computing device, such as the computer 101 as illustrated in FIG. 1, or the server(s) 230 or edge computing device(s) 255 as illustrated in FIG. 2.

As illustrated, the computing device 600 includes a CPU 605, memory 610, storage 615, one or more network interfaces 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated embodiment, the memory 610 includes a model creation component 650, a data preprocessing component 655, a simulation component 660, a prediction component 665, a mitigation component 670, and an implementation component 675. Although depicted as a discrete component for conceptual clarity, in some embodiments, the operations of the depicted component (and others not illustrated) may be combined or distributed across any number of components. Further, although depicted as software residing in memory 610, in some embodiments, the operations of the depicted components (and others not illustrated) may be implemented using hardware, software, or a combination of hardware and software.

In one embodiment, the data preprocessing component 655 may preprocess raw data collected from various sensors (e.g., 202 of FIG. 2), thermal cameras (215 of FIG. 2), and IoT devices (225 of FIG. 2) installed in the industrial location. As stated above, the preprocessing process may include cleaning missing or incomplete data, resolving inconsistencies, normalizing data, and transforming data into a suitable format for further processing and analysis (e.g., model creation, operation simulation, and thermal condition prediction).

In one embodiment, the model creation component 650 may receive the preprocessed data from the data preprocessing component 655, and use the preprocessed data to create a digital twin model (e.g., a 3D model) of the industrial location. The digital twin model may include physical attributes (e.g., size, geometry, and/or layout) of the machines located in the industrial location, as well as environmental factors (e.g., temperature, thermal imaging, humidity, air flow, ventilation, coolant flow, heat influx, and/or infrared radiation) that will impact the thermal conditions of the industrial location. In some embodiments, the digital twin model of the industrial location may serve as a basis for the simulations. In some embodiments, the model creation component 650 may access the digital model library 680 stored in the local storage 615 or a remote database (e.g., 235 of FIG. 2). The digital model library 680 may include a set of example digital twin models associated with machinery, systems, structures, materials, or industrial locations, which are generated based on historical data associated with data feeds collected from various sources (e.g., thermal cameras 215, the sensors 220, and the IoT device 225). In some embodiments, the model creation component 650 may select, based on the type of the machinery at the industrial location, one or more relevant example digital twin models from the plurality of example digital twin models. In some embodiments, the model creation component 650 may create a digital twin model (e.g., a 3D model) of the industrial location, using the selected example digital twin models and the preprocessed data received from the various sensors (e.g., thermal cameras 215, the sensors 220, and the IoT device 225) at the industrial location.

In one embodiment, the simulation component 660 may use the digital twin model of the industrial location to simulate various operations of the machinery and their potential impact on the thermal conditions within the industrial location. In some embodiments, the simulation component 660 may simulate operations (or activities) being performed or to be performed and their potential thermal impacts based on the preprocessed operational data collected from various sensors. These simulations may incorporate a variety of factors, such as the machinery's operational loads or speeds, the machinery's health status, human-machine interactions, materials used for production, lubricants used, and/or coolants used, in order to understand the machinery's behavior under different conditions and how this might influence heat generation and propagation. In some embodiments, the simulation component 660 may use the historical data 685 to simulate the operations of the machinery and/or their potential impact on the thermal conditions within the industrial location. The historical data may be stored in the local storage 615 or a remote database (e.g., 235 of FIG. 2). The historical data may include historical data associated with data feeds (e.g., 310 of FIG. 3) received from various sensors, historical simulation data associated with the machinery and its surroundings (e.g., based on the digital twin models), historical prediction data (e.g., heat generation and propagation), historical mitigation data (e.g., the proactive action recommended), historical implementation data (e.g., the effects of implementing recommended proactive actions), and/or the like.

In one embodiment, the prediction component 665 may utilize trained ML models to predict future thermal conditions (e.g., heat generation and/or propagation) of the industrial location and identify potential thermal issues based on the simulation results and the real-time environmental data.

In one embodiment, the mitigation component 670 may determine one or more proactive actions to mitigate or prevent these predicted thermal issues. In some embodiments, the mitigation component 670 may overlay these proactive actions and their potential mitigating effects onto the digital twin model, which allows users to visualize the potential thermal issues and the corresponding mitigating effects in the context of the simulated industrial location.

In one embodiment, the implementation component 675 may implement the recommended proactive action in the physical environment, either automatically or under certain human supervision. The proactive action may include adjusting the cooling system settings (e.g., increasing the coolant flow rate, improving ventilation, or changing to a more efficient coolant type), changing lubricants, modifying machine loads, halting certain operations, or activating a heat recovery system.

In the illustrated example, the storage 615 may include a digital model library 680 and/or historical data 685. In some embodiments, as depicted in FIG. 2, the aforementioned information may be saved in a remote database 235 that connects to the computing device 600 (e.g., server(s) 230, or edge computing device(s) 255) via a network 210.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

While the foregoing is directed to embodiments of the present invention, other and further embodiments of the invention may be devised without departing from the basic scope thereof, and the scope thereof is determined by the claims that follow.

What is claimed is:

1. A method comprising:
collecting data from one or more sensors in a physical environment;
generating a digital model depicting physical machinery in the physical environment, based on the data collected from the one or more sensors;
simulating one or more operations of the physical machinery, based on the digital model and the data collected from the one or more sensors;
predicting thermal conditions of the physical environment, using a machine learning (ML) model, based on the simulating of the operations and the data collected from the one or more sensors;
generating a recommendation comprising one or more proactive actions to mitigate potential thermal issues, based on the predicted thermal conditions; and
projecting the predicted thermal conditions, the potential thermal issues, and the one or more proactive actions into the digital model via an augmented-reality (AR) display.

2. The method of claim 1, further comprising:
predicting a mitigating effect for each of the one or more proactive actions; and
updating the digital model to reflect the predicted mitigating effect for each of the one or more proactive actions.

3. The method of claim 2, further comprising implementing the one or more proactive actions based on the updated digital model.

4. The method of claim 1, wherein the one or more proactive actions comprises at least one of (i) dynamically controlling coolant flow; (ii) activating cooling procedures; or (iii) implementing heat recovery measures.

5. The method of claim 1, wherein the one or more sensors comprise at least one of a temperature sensor, a thermal imaging camera, a humidity sensor, an air flow sensor, an infrared radiometer, or a heat flux sensor.

6. The method of claim 1, wherein the data comprises at least one of thermal environmental data of the physical environment, or operational data associated with the physical machinery.

7. The method of claim 6, wherein the thermal environmental data comprises at least one of temperature, thermal imaging, humidity, air flow, ventilation, coolant flow, heat influx, or infrared radiation.

8. The method of claim 6, wherein the operational data comprises at least one of activities being performed or to be performed by the physical machinery, materials used by the physical machinery, health status of the physical machinery, or maintenance records.

9. The method of claim 1, wherein the ML model comprises a neural network algorithm, and is trained to predict the thermal conditions of the physical environment.

10. The method of claim 1, wherein the ML model is trained by using historical simulation data and historical data collected from the one or more sensors as input, using historical thermal conditions as target output, and wherein the ML model learns to correlate the historical simulation data and the historical data collected from the one or more sensors to the historical thermal conditions.

11. A system, comprising:
one or more computer processors; and
a memory containing a program which when executed by the one or more computer processors performs an operation, the operation comprising:
collecting data from one or more sensors in a physical environment;
generating a digital model depicting physical machinery in the physical environment, based on the data collected from the one or more sensors;
simulating one or more operations of the physical machinery, based on the digital model and the data collected from the one or more sensors;
predicting thermal conditions of the physical environment, using a machine learning (ML) model, based on the simulating of the operations and the data collected from the one or more sensors;
generating a recommendation comprising one or more proactive actions to mitigate potential thermal issues, based on the predicted thermal conditions; and
projecting the predicted thermal conditions, the potential thermal issues, and the one or more proactive actions into the digital model via an augmented-reality (AR) display.

12. The system of claim 11, wherein the operation further comprises:
predicting a mitigating effect for each of the one or more proactive actions; and
updating the digital model to reflect the predicted mitigating effect for each of the one or more proactive actions.

13. The system of claim 12, wherein the operation further comprises implementing the one or more proactive actions based on the updated digital model.

14. The system of claim 11, wherein the one or more proactive actions comprises at least one of (i) dynamically controlling coolant flow; (ii) activating cooling procedures; or (iii) implementing heat recovery measures.

15. The system of claim 11, wherein the ML model is trained by using historical simulation data and historical data collected from the one or more sensors as input, using historical thermal conditions as target output, and wherein the ML model learns to correlate the historical simulation data and the historical data collected from the one or more sensors to the historical thermal conditions.

16. A computer program product comprising one or more computer-readable storage media collectively containing computer-readable program code that, when executed by operation of one or more computer processors, performs an operation comprising:
collecting data from one or more sensors in a physical environment;
generating a digital model depicting physical machinery in the physical environment, based on the data collected from the one or more sensors;
simulating one or more operations of the physical machinery, based on the digital model and the data collected from the one or more sensors;
predicting thermal conditions of the physical environment, using a machine learning (ML) model, based on the simulating of the operations and the data collected from the one or more sensors;
generating a recommendation comprising one or more proactive actions to mitigate potential thermal issues, based on the predicted thermal conditions; and
projecting the predicted thermal conditions, the potential thermal issues, and the one or more proactive actions into the digital model via an augmented-reality (AR) display.

17. The computer program product of claim 16, wherein the operation further comprises:
predicting a mitigating effect for each of the one or more proactive actions; and
updating the digital model to reflect the predicted mitigating effect for each of the one or more proactive actions.

18. The computer program product of claim 16, wherein the operation further comprises implementing the one or more proactive actions based on the updated digital model.

19. The computer program product of claim 16, wherein the one or more proactive actions comprises at least one of (i) dynamically controlling coolant flow; (ii) activating cooling procedures; or (iii) implementing heat recovery measures.

20. The computer program product of claim 16, wherein the ML model is trained by using historical simulation data and historical data collected from the one or more sensors as input, using historical thermal conditions as target output, and wherein the ML model learns to correlate the historical simulation data and the historical data collected from the one or more sensors to the historical thermal conditions.
